(19) United States
(12) Patent Application Publication
(10) Pub. No.: US 2005/0227090 A1
(43) Pub. Date: Oct. 13, 2005

(54) Reduced-reflection film having low-refractive-index layer

(75) Inventors: Kensuke Yoshioka, Handa-shi (JP); Yoshihiro Morimoto, Saitama-shi (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: NOF CORPORATION, Tokyo (JP)

(21) Appl. No.: 10/516,000

(22) PCT Filed: Jul. 4, 2003
(86) PCT No.: PCT/JP03/08535

§ 371 Date: Nov. 29, 2004

(30) Foreign Application Priority Data
Jul. 5, 2002 (JP) 2002-197261

(51) Int. Cl. B32B 9/04

(52) U.S. Cl. 428/447; 428/913

(57) ABSTRACT

A anti-reflection film with pen scratch resistance has a low refractive index layer formed from a raw material composition containing silicon oxide and a crosslinking agent as main components. The raw material composition contains 1 to 10 wt % of a polymerization initiator and 1 to 5 wt % of a polysiloxane resin with respect to the sum of silicon oxide and the crosslinking agent.

### TECHNICAL FIELD

The present invention relates to an anti-reflection film, in particular, an anti-reflection film excellent in pen sliding durability, scratch resistance and abrasion resistance, and suitable for touch panels.

### BACKGROUND ART

Touch panels have been known as a device arranged on the display surface of various types of display devices such as liquid crystal display devices and cathode ray tubes (CRT), and allows information input through touching the image plane. A typical example of the touch panels is a resistive touch panel which is composed of two sheets of transparent electrode substrates arranged in such a way that the conductive layers provided respectively on the substrates face each other.

The transparent electrode substrates for use in a conventional resistive touch panel each include a glass or thermoplastic substrate and a transparent conductive layer laminated on the substrate, made of metal oxides such as indium oxide which contains tin oxide or zinc oxide which contains tin oxide. In the conventional transparent electrode substrate, reflection is caused by a large number of boundary surfaces. The reflection on the plural layers leads to a drawback such that the light transmittance of the transparent electrode substrate is thereby degraded, and consequently the visibility of the display device is degraded.

For the purpose of solving this problem, there have hitherto been proposed touch panels in which anti-reflection films are used. Reduced-reflection films are effective for preventing the degradation of visibility of display devices. However, a conventional anti-reflection film includes an antireflection layer formed by laminating 1 μm or less thick plural thin films. Depending on the thin film thickness, the light wavelength for which reflection is prevented varies, leading to a problem such that even slight scratches and abrasion tend to be noticeable.

For the purpose of solving such problems, Japanese Patent Laid-Open No. 2002-50230 discloses a transparent conductive film including a cured substance layer and a transparent conductive thin film made of an indium-tin composite oxide laminated on a transparent plastic film substrate. Japanese Patent Laid-Open No. 8-12786 discloses an antireflection sheet including many resin layers and many thin layers made of an inorganic material laminated on a substrate. Japanese Patent Laid-Open No. 2003-71990 discloses a scratch-resistant substrate including a transparent substrate, a lower coating film made of a resin composition containing an ionizing radiation curing resin formed on at least one surface of the transparent substrate, and an upper-layer coating film made of an ionizing radiation curing resin formed on the under-layer coating film and having a refractive index lower than that of the under-layer coating film.

In particular, in the transparent conductive film of Japanese Patent Laid-Open No. 2002-50230, the transparent conductive thin film offering the upper surface thereof is formed on a cured substance layer by sputtering an indium-tin composite oxide. Consequently, the upper surface of the transparent conductive thin film is relatively low in the durability against the sliding rubbing exerted by an input pen (hereinafter referred to as pen sliding durability), and also low in resistance to scratch and abrasion (scratch resistance and abrasion resistance).

Additionally, in Japanese Patent Laid-Open Nos. 8-12786 and 2003-71990, the scratch resistance has been improved, but the three properties of the surface, namely, the pen sliding durability, scratch resistance and abrasion resistance have been found insufficient. In these circumstances, there has been demanded an anti-reflection film having a surface excellent in pen sliding durability, scratch resistance and abrasion resistance.

### DISCLOSURE OF THE INVENTION

An object of the present invention is to provide an anti-reflection film excellent in pen sliding durability, scratch resistance and abrasion resistance, a low refractive index layer for use in the anti-reflection film, and a touch panel and an electronic image display device both using the anti-reflection film.

The present applicants, as a results of a diligent investigation for the purpose of achieving the object, have perfected the present invention by discovering that there is obtained an anti-reflection film excellent in pen sliding durability and so on by optimizing the composition of the reflection reducing layer, in particular, the composition of the low refractive index layer offering the surface of the anti-reflection film.

A first aspect of the present invention provides the low refractive index layer for use in the anti-reflection film formed from a raw material composition containing silicon oxide, a crosslinking agent, a polymerization initiator and a polysiloxane resin. The main components of the raw material composition are silicon oxide and the crosslinking agent. The content of the polymerization initiator is 1 to 10 wt % and the content of the polysiloxane resin is 1 to 5 wt % with respect to the sum of silicon oxide and the crosslinking agent.

A second aspect of the present invention provides a refection reducing film including a substrate, at least one intermediate layer arranged on the substrate and including a hard coat layer, and a reflection reducing layer arranged on the intermediate layer. The reflection reducing layer includes a high refractive index layer and a low refractive index layer arranged on the high refractive index layer. The low refractive index layer is formed from a raw material composition containing silicon oxide, a crosslinking agent, a polymerization initiator and a polysiloxane resin. The content of the polymerization initiator is 1 to 10 wt % and the content of the polysiloxane resin is 1 to 5 wt % with respect to the sum of silicon oxide and the crosslinking agent.

### BEST MODE FOR CARRYING OUT THE INVENTION

In an embodiment of the present invention, a low refractive index layer is formed from a raw material composition containing silicon oxide, a crosslinking agent, a polymerization initiator and a polysiloxane resin. In the raw material composition, silicon oxide and the crosslinking agent are the main components, and the polymerization initiator and the polysiloxane resin are included respectively at specified proportions. Silicon oxide (SiO₂) is a low refractive index material, and the use of fine particles of silicon oxide makes it possible to form a low refractive index layer having a low refractive index. Additionally, silicon oxide has a function to improve the strength of the low refractive index layer in such a way that silicon oxide enhances the bonding forces between other components in the low refractive index layer. The average particle size of the silicon oxide fine particles preferably does not exceed the thickness of the low refractive index layer to a large extent, and is particularly preferably 0.1 μm or less. When the average particle size of the silicon oxide fine particles is larger than the thickness of the low refractive index layer, scattering is caused and the optical performance of the low refractive index layer is thereby degraded.

According to need, the surface of the silicon oxide fine particles can be modified by use of various types of coupling agents. Examples of the various types of coupling agents include silicon compounds subjected to organic substitution; alkoxides of metals such as aluminum, titanium, zirconium and antimony; and organic acids. In particular, modification of the surface of silicon oxide particles with reactive groups such as (meth)acryloyl group is preferable because the surface hardness of the low refractive index layer is thereby improved.

The blend content of silicon oxide is preferably 50 to 95 wt %, more preferably 60 to 90 wt %, with respect to the sum of the contents of the main components, namely, silicon oxide and the crosslinking agent. When the proportion of silicon oxide is less than 50 wt %, it becomes difficult to obtain a low refractive index layer having a sufficient strength, while when the proportion of silicon oxide exceeds 95 wt %, the crosslink density is low, yielding as a result an insufficiently cured, low refractive index layer.

The crosslinking agent is blended for the purpose of improving the surface hardness, the strength and the scratch resistance of the low refractive index layer. The crosslinking agent serves to form a crosslinked structure in the low refractive index layer. Examples of the crosslinking agent include polyethylene glycol di(meth)acrylate, diethylene glycol di(meth)acrylate, glycerol di(meth)acrylate, trimethylolpropane tri(meth)acrylate, pentaerythritol (meth)acrylate, dipentaerithritol penta(meth)acrylate, dipentaerithritol hexa(meth)acrylate, ditrimethylolpropane tetra(meth)acrylate, and pentaerithritol tetra(meth)acrylate.

The type of the crosslinking agent is not limited, but (meth)acrylate monomers with functionality of 3 to 6 are preferable because the surface hardness, the strength and the scratch resistance of the low refractive index layer is further improved in such a way that a dense 3-dimensional network structure is formed in the low refractive index layer. The blend content of the crosslinking agent is preferably 5 to 50 wt %, more preferably 10 to 40 wt %, with respect to the sum of silicon oxide and the crosslinking agent. When the proportion of the crosslinking agent is less than 5 wt %, the surface hardness of the low refractive index layer becomes insufficient, while the proportion of the crosslinking agent exceeds 50 wt %, the pen sliding durability and the scratch resistance of the low refractive index layer tend to be degraded.

The polymerization initiator used in the present invention polymerizes the crosslinking agent and causes curing. Examples of the crosslinking agent include photopolymerization initiators such as 2,2′-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyldimethylketal, N,N,N′,N′-tetramethyl-4,4′-diaminobenzophenone, 1-(4-isopropylphenyl)-2-hydroxy-2-methylpropan-1-one, 2-hydroxy-2-methyl-1-phenylpropan-1-one, 2-methyl-1[4-(methylthio)phenyl]-2-morpholinopropan-1-one, and other thioxanthone based compounds; and thermopolymerization initiators such as ketone peroxides, peroxyketals, hydroperoxides, dialkyl peroxides, diacyl peroxides, and peroxydicarbonates.

Among the above initiators, preferable are the photopolymerization initiators such as 2-methyl-1[4-(methylthio)phenyl]-2-morpholinopropan-1-one from the aspect of the productivity and the strength of the low refractive index layer. The photopolymerization initiators may be used each alone, or may be used in combinations of two or more thereof.

The blend content of the polymerization initiator is 1 to 10 wt %, preferably 3 to 7 wt %, with respect to the sum of silicon oxide and the crosslinking agent. When the content of the polymerization initiator is less than 1 wt %, it becomes difficult to obtain a low refractive index layer having a sufficient strength, while when the content of the polymerization initiator exceeds 10 wt %, the antireflection performance of the low refractive index layer is degraded because of the increase of the refractive index of the low refractive index layer.

The polysiloxane resin used in the present invention improves, owing to the sliding property thereof, mainly the pen sliding durability of the surface of the low refractive index layer, and moreover, improves the abrasion resistance of the surface of the low refractive index layer. Examples of such a polysiloxane resin include polyamino modified polysiloxane, polyepoxy modified polysiloxane, polyalcohol modified polysiloxane, polycarboxyl modified polysiloxane, polymercapto modified polysiloxane, polyester modified polysiloxane, and polyether modified polysiloxane. Among these, preferable are polyester modified polysiloxane and polyether modified polysiloxane from the aspect of improving the strength of the low refractive index layer.

From the aspect of improving the surface hardness of the low refractive index layer, it is more preferable that in any of the polysiloxane resins, the main chain part of the polysiloxane is modified with dimethyl groups; and among the polyester modified polysioloxane and polyether modified polysiloxane, particularly preferable are polyester modified dimethyl polysiloxane and polyether modified dimethyl polysiloxane.

Examples of commercially available polysiloxane resins include a polysiloxane resin (product name: VXL 4930) manufactured by Vianova Resins GmbH, a polysiloxane resin (product name: BYK 306) manufactured by BYK-Chemie Co., Ltd., and a polysiloxane resin (product name: Disparlon 1751N) manufactured by KUSUMOTO CHEMICALS, Ltd. The blend content of the polysiloxane resin is 1 to 5 wt %, preferably 1.5 to 4 wt %, with respect to the sum of silicon oxide and the crosslinking agent. When the content of the polysiloxane is less than 1 wt %, the scratch resistance and the pen sliding durability of the low refractive index layer are degraded, while when the content of the polysiloxane exceeds 5 wt %, the abrasion resistance of the low refractive index layer is degraded.

Additives other than the above described compounds may be added to the raw material composition for the low refractive index layer as far as the effect of the present invention is not impaired. Examples of such additives include inorganic or organic pigments, polymers, polymerization inhibitors, antioxidants, dispersants, surfactants, photostabilizers and leveling agents.

When the raw material composition is applied according to a wet coating method and is dried to form the low refractive index layer, a solvent can be added in an arbitrary amount to the raw material composition. According to this wet coating method, the low refractive index layer can be easily formed, and hence the production cost for the anti-reflection film is reduced.

A method for forming the low refractive index layer will now be discussed. Before forming the low refractive index layer, there is prepared a substrate with a functional layer laminated thereon. The raw material composition for the low refractive index layer is applied onto the functional layer by means of an appropriate coating method such as a wet coating method. The low refractive index layer is formed by curing the raw material composition through heating or irradiating with an active energy ray such as ultraviolet light and electron beam.

It is preferable that the curing reaction with the aid of an active energy ray is carried out in the atmosphere of an inert gas such as nitrogen and argon. As the source of the active energy ray, for example, there are used a high pressure mercury lamp, a halogen lamp, a xenon lamp, a nitrogen laser, an electron beam accelerator, and a radioactive element. It is preferable that the irradiation dose of the active energy ray source is such that the integrated amount of light for the ultraviolet wavelength of 365 nm is 50 to 5,000 mJ/cm². When the irradiation dose is less than 50 mJ/cm², curing becomes insufficient, and hence the surface hardness of the low refractive index layer is degraded, while when the irradiation dose exceeds 5,000 mJ/cm², the low refractive index layer tends to be colored and hence the transparency of the low refractive index layer tends to be degraded.

In the case where curing is carried out by heating, a thermopolymerization initiator well known in the art is beforehand added to the aforementioned raw material composition. After the raw material composition has been applied, the raw material composition is heated to a temperature equal to or above the thermal decomposition temperature of the thermopolymerization initiator and the raw material composition is thereby cured to form the low refractive index layer.

The anti-reflection film of the present invention includes a substrate, at least one intermediate layer, inclusive of a hard coat layer, laminated on the substrate, and a reflection reducing layer arranged on the intermediate layer. The reflection reducing layer includes a high refractive index layer and a low refractive index layer laminated on the high refractive index layer. The low refractive index layer is formed of the above described raw material composition.

From the aspect of transparency and workability, preferable is a transparent resin film in which the refractive index of the substrate falls preferably within the range from 1.45 to 1.70, and the thickness of the substrate falls within the range from 10 to 500 μm. Here, “transparent” means that the light transmittance is 30% or more. The light transmittance is more preferably 50% or more, further more preferably 80% or more.

For the substrate, polyethylene terephthalate (PET), polybutylene terephthalate (PBT), polyethylene naphthalate (PEN), polycarbonate (PC), polyimide, polyarylate, polyacrylate, polyether ketone, polysulfone, polyether sulfone and polyether imide are preferable. Particularly, because of easy availability and cost, polyethylene terephthalate (PET) and polycarbonate (PC) are preferable. In the present invention, a hard coat layer is arranged between the substrate and the reflection reducing layer. No particular constraint is imposed on the types and refractive indexes of the materials for the hard coat layer. Examples of the materials for the hard coat layer include cured substances obtained from monofunctional (meth)acrylates, multifunctional (meth)acrylates and reactive silicon compounds such as tetraethoxysilane. In the present invention, (meth)acryl means both methacryl and acryl; thus, (meth)acrylate indicates both methacrylic acid ester and acrylic acid ester.

From the aspect of improving the surface hardness, more preferable is a polymerized, cured substance obtained from a composition containing an ultraviolet curing, multifunctional (meth)acrylate. Additionally, when the refractive index of the substrate and the refractive index of the hard coat layer are largely different from each other, the external appearance is impaired by interference, and hence an interference preventing layer may be arranged therebetween. Additionally, it is desirable that the hard coat layer has an antiglare effect. For example, a hard coat layer provided with irregularities displays an antiglare effect. No constraint is imposed on the types and refractive indexes of the materials for providing irregularities on the hard coat layer, as far as the effect of the present invention is not impaired. For example, a hard coat layer having an antiglare property is obtained by forming the hard coat layer with particles of resins such as acrylic resin, polystyrene based resin and polycarbonate based resin by use of a method well known in the art. These resin particles may be used each alone or as a mixture composed of two or more thereof. It is preferable that the particle sizes of the resin particles are 1 to 5 μm.

The method for forming the hard coat layer is not limited. When an organic material is used, the hard coat layer can be formed on the basis of a general wet coat method such as the roll coat method and the die coat method. In this case, the hard coat layer can be formed by curing on the basis of appropriate heating after coating, and by curing with irradiation of an active energy ray such as ultraviolet light and electron beam after coating.

It is preferable that the hard coat layer is 2 to 25 μm in thickness. When the thickness is less than 2μm, the surface hardness of the anti-reflection film is degraded, and hence an anti-reflection film having a sufficient hardness can be hardly obtained. On the other hand, a hard coat layer exceeding 25 μm in thickness degrades the flexibility of the anti-reflection film. In the case where plural hard coat layers are laminated, the total thickness has only to be 2 to 25 μm, and no particular constraint is imposed on the thickness of each of the layers, and the layers may be different in thickness from each other.

In the case where the substrate or the intermediate layer inclusive of the hard coat layer has a function of a high refractive index layer, the reflection reducing layer may take a single layer structure formed only of a low refractive index layer instead of a multilayer structure including both of a low refractive index layer and a high refractive index layer.

Examples of the reflection reducing layer having a multilayer structure include a two-layer structure composed of a high refractive index layer and a low refractive index layer, a three-layer structure composed of a intermediate refractive index layer, a high refractive index layer and a low refractive index layer, and a four-layer structure composed of a high refractive index layer, a low refractive index layer, a high refractive index layer and a low refractive index layer, all the layers in each structure being arranged in the order from the layer nearest to a transparent resin film as the substrate. From the aspect of productivity, cost and reflection reducing effect, it is preferable that the reflection reducing layer takes a two-layer structure.

In order for the reflection reducing layer to exhibit a sufficient function, it is important that the refractive index of the low refractive index layer is lower than the refractive index of the layer located immediately beneath the low refractive index layer (namely, the layer nearer to the substrate than the low refractive index layer). It is preferable that the refractive index of the low refractive index layer falls within the range from 1.3 to 1.5. When the refractive index of the low refractive index layer is less than 1.3, it becomes difficult to obtain a reflection reducing layer having a sufficient hardness, while when the refractive index of the low refractive index layer exceeds 1.5, the reflection reducing effect of the reflection reducing layer tends to be insufficient.

In the case where the reflection reducing layer takes a two-layer structure, it is important that the refractive index of the high refractive index layer is higher than the refractive index of the low refractive index layer laminated immediately above the high refractive index layer. It is preferable that the refractive index of the high refractive index layer falls within the range from 1.6 to 2.4. When the refractive index of the high refractive index layer is less than 1.6, it becomes difficult to obtain a sufficient reflection reducing effect, while when the refractive index of the high refractive index layer exceeds 2.4, the formation of the reflection reducing layer based on a wet coating method tends to be difficult. It is preferable that the difference between the refractive index of the high refractive index layer and the refractive index of the low refractive index layer is 0.1 or more. When this is the case, the reflection reducing layer exhibits a sufficient reflection reducing effect.

In the case where the reflection reducing layer takes the multilayer structure composed of a intermediate refractive index layer, a high refractive index layer and a low refractive index layer, no particular constraint is imposed on the refractive index of the intermediate refractive index layer, as far as the refractive index of the intermediate refractive index layer is lower than the refractive index of the high refractive index layer and higher than the refractive index of the low refractive index layer.

The optical film thickness of each of the layers in the reflection reducing layer varies depending on the type and shape of the substrate and the structure of the reflection reducing layer, but is preferably equal to or less than one fourth the visible light wavelength. For example, for the purpose of reducing the reflection of visible light (to cover wavelengths from 400 to 800 nm), the optical film thickness (n×d) of each of the layers in the reflection reducing layer is designed so as to satisfy the expression:
400≦4×n×d≦800 (nm),
where n and d denote the refractive index and thickness of each layer, respectively.

Inorganic materials and organic materials can be used for the high refractive index layer and the intermediate refractive index layer, without any particular constraint imposed on these materials. Examples of the inorganic materials include zinc oxide, titanium oxide, cerium oxide, aluminum oxide, silane oxide, tantalum oxide, yttrium oxide, ytterbium oxide, zirconium oxide, antimony oxide, and indium oxide-tin (hereinafter referred to as ITO as the case may be). Particularly, from the aspect of conductivity and antistatic ability, tin oxide, antimony oxide, and indium oxide-tin are preferable; from the aspect of high refractive index, titanium oxide, cerium oxide, zinc oxide and zirconium oxide are preferable. The shapes of the inorganic materials are, for example, fine particles.

As the organic materials, for example, there can be used a polymerized, cured substance obtained from a composition containing a polymerizable monomer having a refractive index of 1.6 to 1.8. Examples of the polymerizable monomer having a refractive index of 1.6 to 1.8 include 2-vinylnaphthalene, 4-bromostyrene, and 9-vinylanthracene.

Inorganic material fine particles and organic materials can be used at the same time. In this case, polymerizable monomers other than the polymerizable monomer having a refractive index of 1.6 to 1.8, or a composition containing the polymers derived from these monomers can be used as binders at the time of wet coating. It is preferable that the average particle size of each of the inorganic fine particles does not largely exceeds the layer thickness, and it is particularly preferable that the average particle size is 0.1 μm or less. When the average particle size of the fine particles of the inorganic material concerned comes to be larger than the thickness of the relevant layer, scattering occurs and the optical performance of the high refractive index layer or the intermediate refractive index layer tends to be degraded.

According to need, the surface of the fine particles can be modified by use of various types of coupling agents. Examples of the various types of coupling agents include silicon compounds subjected to organic substitution; alkoxides of metals such as aluminum, titanium, zirconium and antimony; and organic acid salts.

For the methods for forming the high refractive index layer and the intermediate refractive index layer, methods well known in the art can be used. Examples of such methods include dry coating methods such as vapor deposition, sputtering, chemical vapor deposition (CVD) and ion plating; and wet coating methods such as dip coating, roll coating, gravure coating and die coating. Among these methods, a method permitting continuous formation such as the roll coating method is preferable from the aspect of the productivity.

An adhesive layer may be arranged on the underside of the substrate, namely, the side opposite to the side on which the intermediate layer is laminated. In this case, the low refractive index layer is the uppermost layer in the anti-reflection film, and the adhesive layer is the lowermost layer of the anti-reflection film. No particular constraint is imposed on the material for the adhesive layer, and examples of such a material include acrylic adhesive agents, ultraviolet curing adhesive agents and thermosetting adhesive agents. For the purpose of blocking a particular wavelength region of light, improving contrast, or correcting color tone, the material for the adhesive layer may include one or more materials having these functions. For example, in such an unfavorable case where the transmitted light from the anti-reflection film is colored in yellow, the color tone of the transmitted light can be corrected by adding dyes.

It is preferable that after a predetermined pen has been made to carry out 50,000 back and forth sliding strokes with a load of 300 g on the surface of the low refractive index layer, no visually identifiable scratches are formed on the surface. Additionally, it is preferable that after a predetermined piece of steel wool has been made to carry out 50 back and forth rubbing strokes with a load of 250 g on the surface of the low refractive index layer, no visually identifiable scratches are formed on the surface. A anti-reflection film having such a hardly vulnerable, low refractive index layer as described above is preferable for use in touch panels.

The anti-reflection film of the present invention can be used for reducing reflection, and particularly, can be used for suppressing the reflection from the surface of the display plate of an electronic image display device. Examples of the electronic image display device include CRTs, plasma display panels (PDPs), and liquid crystal display devices. The anti-reflection film is used in such a way that the film is directly or indirectly through the intermediary of an adhesive layer adhered onto the surface of the display plate of an electronic image display device.

The low refractive index layer for use in the anti-reflection film is formed by curing under ultraviolet irradiation a raw material composition prepared by mixing together silicon oxide, a crosslinking agent, a polymerization initiator and a polysiloxane resin. In the raw material composition, silicon oxide and the crosslinking agent are the main components. The raw material composition contains 1 to 10 wt % of the polymerization initiator and 1 to 5 wt % of the polysiloxane resin with respect to the sum of silicon oxide and the crosslinking agent. The anti-reflection film is formed by laminating an intermediate layer inclusive of a hard coat layer on a film (substrate) of a transparent resin such as polyethylene terephthalate and laminating a reflection reducing layer on the intermediate layer. The reflection reducing layer includes a high refractive index layer arranged in a position nearer to the substrate and a low refractive index layer arranged in a position farther from the substrate. In other words, the intermediate layer (the hard coat layer) and the reflection reducing layer (the high refractive index layer and the low refractive index layer) are laminated in this order on the substrate, and the low refractive index layer offers the surface of the anti-reflection film. The low refractive index layer is formed of the above described raw material composition.

In the anti-reflection film, silicon oxide is a material taking a particulate form and having a low refractive index so that the refractive index of the low refractive index layer is relatively low and the strength thereof is high. Crosslinked structure is formed in the low refractive index layer through the crosslinking agent subjected to polymerization curing triggered by the polymerization initiator so that the strength of the low refractive index layer and the surface hardness are improved. Consequently, scratching of the surface of the low refractive index layer can be suppressed. Additionally, the polysiloxane resin has siloxane groups so that the surface of the low refractive index layer is satisfactory in sliding property and, is excellent in resistance against abrasion in such a way that no variation is found in the sliding property even when an input pen is repeatedly made to slide on the surface.

According to an embodiment, the following advantages are obtained.

The low refractive index layer is formed from a raw material composition containing, as the indispensable components, silicon oxide, a crosslinking agent, a polymerization initiator and a polysiloxane resin. The polymerization initiator is added in the content of 1 to 10 wt % and the polysiloxane resin is added in the content of 1 to 5 wt %, with respect to the sum of silicon oxide and the crosslinking agent. The effects of the respective components improve the three properties of the surface of the low refractive index layer, namely, the sliding pen durability, the scratch resistance and the abrasion resistance.

The anti-reflection film has a reflection reducing layer laminated at least on one or more intermediate layers inclusive of a hard coat layer. The reflection reducing layer includes a high refractive index layer and a low refractive index layer arranged in order from a position nearer to the substrate. Because the low refractive index layer is formed of the above described material, the pen sliding durability, the scratch resistance and the abrasion resistance in the surface of the anti-reflection film are improved.

The surface of the hard coat layer is provided with irregularities so that the anti-reflection film has an antiglare effect.

The refractive index of the high refractive index layer is 1.6 to 2.4, and the refractive index of the low refractive index layer is 1.3 to 1.5, and thus, the difference between the refractive index of the high refractive index layer and the refractive index of the low refractive index layer is 0.1 or more so that the anti-reflection film effectively reduces light reflection.

The substrate is a transparent resin film having a thickness of 10 to 500 μm so that the light transmittance property and the handlability of the anti-reflection film are excellent.

An adhesive layer is arranged on the underside of the substrate, and hence the anti-reflection film can be adhered onto the display plate of an electronic image display device such as a plasma display panel. When no adhesive layer is arranged, the anti-reflection film may be arranged so as for the substrate to be directly in contact with the display plate of the electronic image display device.

The anti-reflection film has the low refractive index layer excellent in pen sliding durability so that no visually identifiable scratches are formed even after an input pen has been made to carry out 50,000 back and forth sliding strokes with a load of 300 g.

The anti-reflection film has the low refractive index layer excellent in abrasion resistance so that no visually identifiable scratches are formed after a piece of steel wool has been moved in 50 back and forth rubbing strokes with a load of 250 g.

The reflection reducing layer is fabricated by a wet coating method, and accordingly the formation thereof is easy and efficient. Consequently, the anti-reflection film is manufactured at a low cost.

The anti-reflection film of an embodiment has the above described advantages, and is thereby useful as a film to be adhered onto the display plate of a touch panel for manual inputting and inputting with a pen or the display plate of an electronic image display device. More specifically, when the anti-reflection film is arranged on the display plate of a touch panel or an electronic image display device, the reflection adversely affecting the visibility of the display plate is reduced, and the display plate is hardly vulnerable so that the image of the touch panel or the electronic image display device can be clearly displayed over a long term. Additionally, the surface hardness of the anti-reflection film is appropriate for manual inputting or inputting with a pen, thus the operability of the touch panel or the electronic image display device is improved.

Description will be made below on the examples of the present invention. In the following description on the examples, “%” represents “wt %” unless otherwise specified.

Firstly, methods for evaluating the physical properties of the anti-reflection film or the low refractive index layer will now be explained.

(1) Refractive Index

(i) A coating liquid composed of a solvent and a raw material composition having predetermined ingredients is applied onto an acrylic resin plate (product name: Delaglas A, manufactured by ASAHI KASEI Corporation) having a refractive index of 1.49 by means of a dip coater (manufactured by SUGIYAMA-GEN RIKAGAKUKIKI Co., Ltd.) in such a way that there can be obtained a layer having an optical thickness after drying of the order of 110 nm.

(ii) After the solvent has been dried, according to need, the applied layer is cured to obtain a low refractive index layer by irradiating ultraviolet light from a 120 W high pressure mercury lamp under an atmosphere of nitrogen with a dose of 400 mJ/cm², by use of an ultraviolet irradiation apparatus (manufactured by IWASAKI ELECTRIC Co., Ltd.).

(iii) The surface of the acrylic resin plate, opposite to the surface on which the low refractive index layer has been formed, is coarsened with a piece of sandpaper, solidly coated with a black coating composition, and thus an anti-reflection film sample is fabricated. The ±5° regular reflectance of the anti-reflection film sample is measured for a light beam having the wavelengths from 400 to 650 nm by use of an spectrophotometer (product name: U-best 50, manufactured by JASCO Corporation), and the local minimum or maximum of the reflectance is read out from the reflectance spectrum.

(iv) The refractive index n of the low refractive index layer is calculated according to the following formula, where n_{M} stands for the refractive index of the acrylic resin plate.

$$Local minimum or maximum of reflectance = {( \frac{{n}_{M} - {n}^{2}}{{n}_{M} + {n}^{2}} )}^{2}$$

(2) Minimum Reflectance

The ±5° regular reflectance of the low refractive index layer is measured by means of a spectroreflectometer (product name: U-Best, manufactured by JASCO Corporation), and from the obtained reflectance spectrum, the minimum reflectance (%) of the low refractive index layer was read out. When the interference of the hard coat is observed in the spectrum, the center value between the upper limit and lower limit was read out.

(3) Total Transmittance (%)

The total transmittance of the low refractive index layer is measured by a haze meter (product name: NDH 2000, Nippon Denshoku Industries Co., Ltd.).

(4) Steel Wool Scratching Test

A piece of steel wool (#0000) applied with a predetermined load (250 g) is made to carry out 50 back and forth rubbing strokes on the surface (the upper surface of the low refractive index layer) of the anti-reflection film sample, and then the surface condition is observed.

The observed results are evaluated on the basis of the following 4 grades, and listed in Table 1 under the heading of scratch resistance. A: no identifiable scratches, B: 1 to 10 identifiable scratches, C: 10 to 20 identifiable scratches, D: 20 or more identifiable scratches.

(5) Abrasion Resistance

A piece of tissue paper (product name: Wiper S-200, manufactured by Crecia Corp.) folded three times in half, applied with a load of 1 kg is made to carry out 1,000 rubbing strokes on the surface (the upper surface of the low refractive index layer) of the anti-reflection film sample, and then the extent of the external appearance change is observed.

The results obtained are evaluated on the basis of the following grades. ◯: no change, Δ: slight change in reflected color, x: remarkable change in reflected color or the exfoliation of the reflection reducing layer.

(6) Pen Sliding Durability

The anti-reflection film sample is adhered on a 2 mm thick sheet of glass plate with a transparent adhesive tape (product name: Noncarrier, Lintec Corporation) so as for the low refractive index layer to be the uppermost layer.

An eraser tester (manufactured by Motomitsu Seisakusho Co., Ltd.) is equipped with a pen made of polyacetal having a spherical tip of 0.8 mm in radius, and the pen tip is moved in straight stroke in contact with the surface of the low refractive index layer. The conditions involved are as follows: the load: 300 gf, the number of times: 100,000 (50,000 back and forth strokes), the stroke length: 25 mm, the movement velocity: 100 mm/s. After 50,000 back and forth strokes, the surface of the sample is visually observed. This test is repeated 5 times and the number n of the tests producing no scratches is counted. The number thus obtained is listed in Table 1 as in the form of “n/the number of the tests (5).”

### PREPARATION EXAMPLE 1

### Preparation of Coating Liquid (HC-1) for Hard Coat Layer)

The coating liquid (HC-1) for use in the hard coat layer was prepared by mixing together 70 parts by weight of dipentaerithritol hexaacrylate, 20 parts by weight of tetramethylolmethane triacrylate, 10 parts by weight of 1,6-bis(3-acryloyloxy-2-hydroxypropyloxy)hexane, 20 parts by weight of an indium oxide-tin fine particle (the average particle size: 0.07 μm), 4 parts by weight of a photopolymerization initiator (product name: IRGACURE 184, manufactured by Ciba-Geigy Ltd.), and 100 parts by weight of isopropanol.

### PREPARATION EXAMPLE 2

### Preparation of Coating Liquid (H-1) for High Refractive Index Layer

The coating liquid (H-1) for use in the high refractive index layer was prepared by mixing together 85 parts by weight of a zinc oxide fine particle (average particle size: 0.06 μm), 12 parts by weight of pentaerithritol hexaacrylate, 3 parts by weight of tetramethylolmethane triacrylate, 900 parts by weight of butyl alcohol, and 1 part by weight of a photopolymerization initiator (product name: IRGACURE 907, manufactured by Ciba-Geigy Ltd.). The refractive index of a cured substance obtained after drying the solvent was 1.71.

### PREPARATION EXAMPLE 3

### Preparation of Coating Liquid (H-2) for High Refractive Index Layer

The coating liquid (H-1) for use in the high refractive index layer was prepared by mixing together 50 parts by weight of an indium oxide-tin fine particle (the average particle size: 0.06 μm), 20 parts by weight of pentaerithritol hexaacrylate, 30 parts by weight of tetramethylolmethane triacrylate, 900 parts by weight of butyl alcohol, and 2 parts by weight of a photopolymerization initiator (product name: IRGACURE 907, manufactured by Ciba-Geigy Ltd.). The refractive index of a cured substance obtained after drying the solvent was 1.64.

### PREPARATION EXAMPLE 4

### Preparation of Coating Liquid (L-1) for Low Refractive Index Layer

The coating liquid (L-1) for use in the low refractive index layer was prepared by mixing together 100 parts by weight of the main component composed of 90% of a dispersion liquid of silicon oxide fine particle (product name: XBA-ST, manufactured by NISSAN CHEMICAL INDUSTRIES, LTD., the average particle size: 10 to 50 nm) and 10% of dipentaerithritol hexaacrylate, and 5 parts by weight of a photopolymerization initiator (product name: IRGACURE 907, manufactured by Ciba-Geigy Ltd.). The refractive index of a polymerized, cured substance obtained from L-1 was 1.49.

### PREPARATION EXAMPLE 5

### Preparation of Coating Liquid (L-2) for Low Refractive Index Layer

The coating liquid (L-2) for use in the low refractive index layer was prepared by mixing together 100 parts by weight of the main component composed of 90% of a dispersion liquid of silicon oxide fine particle (product name: XBA-ST, manufactured by NISSAN CHEMICAL INDUSTRIES, LTD., the average particle size: 10 to 50 nm) and 10% of dipentaerithritol hexaacrylate, 5 parts by weight of a photopolymerization initiator (product name: IRGACURE 907, manufactured by Ciba-Geigy Ltd.), and 2 parts by weight of a polysiloxane resin (product name: VXL 4930, manufactured by Vianova Resins GmbH). The refractive index of a polymerized, cured substance obtained from L-2 was 1.49.

### PREPARATION EXAMPLE 6

### Preparation of Coating Liquid (L-3) for Low Refractive Index Layer)

The coating liquid (L-3) for use in the-low refractive index layer was prepared by mixing together 100 parts by weight of the main component composed of 90% of a dispersion liquid of silicon oxide fine particle (product name: XBA-ST, manufactured by NISSAN CHEMICAL INDUSTRIES, LTD., the average particle size: 10 to 50 nm) and 10% of dipentaerithritol hexaacrylate, 5 parts by weight of a photopolymerization initiator (product name: IRGACURE 907, manufactured by Ciba-Geigy Ltd.), and 2 parts by weight of a polyether modified polysiloxane resin (product name: BYK 306, manufactured by BYK-Chemie, Co., Ltd.). The refractive index of a polymerized, cured substance obtained from L-3 was 1.49.

### PREPARATION EXAMPLE 7

### Preparation of Coating Liquid (L-4) for Low Refractive Index Layer)

The coating liquid (L-4) for use in the low refractive index layer was prepared by mixing together 100 parts by weight of the main component composed of 90% of a dispersion liquid of silicon oxide fine particle (product name: XBA-ST, manufactured by NISSAN CHEMICAL INDUSTRIES, LTD., the average particle size: 10 to 50 nm) and 10% of dipentaerithritol hexaacrylate, 5 parts by weight of a photopolymerization initiator (product name: IRGACURE 907, manufactured by Ciba-Geigy Ltd.) and 2 parts by weight of a polysiloxane resin (product name: Disparlon 1751N) manufactured by KUSUMOTO CHEMICALS, Ltd. The refractive index of a polymerized, cured substance obtained from L-4 was 1.49.

### PREPARATION EXAMPLE 8

### Preparation of Coating Liquid (L-5) for Low Refractive Index Layer

The coating liquid (L-5) for use in the low refractive index layer was prepared in the same way as in Preparation Example 5 except that the addition amount of the polysiloxane resin was altered from 2 parts by weight to 0.5 part by weight. The refractive index of a polymerized, cured substance obtained from L-5 was 1.49.

### PREPARATION EXAMPLE 9

### Preparation of Coating Liquid (L-6) for Low Refractive Index Layer

The coating liquid (L-6) for use in the low refractive index layer was prepared in the same way as in Preparation Example 6 except that the addition amount of the polysiloxane resin was altered from 2 parts by weight to 7 parts by weight. The refractive index of a polymerized, cured substance obtained from L-6 was 1.49.

### EXAMPLES 1 to 4

The coating liquid HC-1 prepared in Preparation Example 1 was applied onto a 188 μm thick sheet of PET film (product name: A4100, manufactured by Toyobo Co., Ltd.) by means of a bar coater so as for the dried thickness to be of the order of 4 μm. The coating thus obtained was cured by irradiating ultraviolet light from a 120 W high pressure lamp with a dose of 400 mJ/cm², by use of an ultraviolet irradiation apparatus (manufactured by IWASAKI ELECTRIC Co., Ltd.), and thus, a PET film subjected to hard coating treatment was fabricated.

On the PET film thus obtained, the coating liquids H-1 and H-2 for use in the high refractive index layer, prepared respectively in Preparation Examples 2 and 3, were applied by means of a dip coater (manufactured by SUGIYAMA-GEN RIKAGAKUKIKI Co., Ltd.), in such a way that there was obtained for each of the coating liquids a film in which the optical film thickness after drying was of the order of 550 nm. Each of the films thus obtained was cured by irradiating ultraviolet light from a 120 W high pressure mercury lamp under an atmosphere of nitrogen with a dose of 400 mJ/cm², by an ultraviolet irradiation apparatus (manufactured by IWASAKI ELECTRIC Co., Ltd.).

In a similar manner, onto the high refractive index layer, the coating liquids L-2 to L-4 for use in the low refractive index layer prepared in Preparation Examples 5 to 7 were respectively applied in such a way that each of the coating liquids had been prepared to exhibit a minimum reflectance for the dried film thickness of 550 nm, and thereafter, the films thus obtained were respectively cured to yield anti-reflection films.

The minimum reflectance, the total transmittance, the scratch resistance, the abrasion resistance and the pen sliding durability were evaluated for each of the anti-reflection films thus obtained. The results obtained are shown in Table 1. Incidentally, the anti-reflection films obtained in Examples 1 to 4 were subjected to surface hardness measurement and were all found to have a pencil hardness of 3H.

### COMPARATIVE EXAMPLES 1 TO 4

Reflection reducing films were fabricated in the same way as in Example 1 except that L-1, L-5 and L-6 were used as the coating liquids for use in the low refractive index layer.

Additionally, the minimum reflectance, the total transmittance, the scratch resistance, the abrasion resistance and the pen sliding durability were evaluated for each of the anti-reflection films thus obtained in the same way as in Example 1. The results obtained are shown in Table 1.

TABLE 1

| | | | | | Comparative | | | |
|---|---|---|---|---|---|---|---|---|
| | Examples | | | | Examples | | | |
| | 1 | 2 | 3 | 4 | 1 | 2 | 3 | 4 |
| Hard coat layer | HC-1 | HC-1 | HC-1 | HC-1 | HC-1 | HC-1 | HC-1 | HC-1 |
| high refractive | H-1 | H-1 | H-1 | H-2 | H-1 | H-1 | H-1 | H-2 |
| index layer | | | | | | | | |
| polysiloxane | 2 | 2 | 2 | 2 | 0 | 0.5 | 7 | 0 |
| (parts) | | | | | | | | |
| low refractive | L-2 | L-3 | L-4 | L-2 | L-1 | L-5 | L-6 | L-1 |
| index layer | | | | | | | | |
| minimum | 0.9 | 0.9 | 0.9 | 0.7 | 0.9 | 0.9 | 0.9 | 0.7 |
| reflectance (%) | | | | | | | | |
| total | 91.9 | 92.0 | 91.8 | 92.3 | 91.9 | 91.9 | 92.1 | 92.4 |
| transmittance | | | | | | | | |
| (%) | | | | | | | | |
| scratch | A | A | A | A | D | C | A | D |
| resistance | | | | | | | | |
| abrasion | Δ | ◯ | ◯ | Δ | ◯ | ◯ | X | ◯ |
| resistance | | | | | | | | |
| pen | 4/5 | 3/5 | 3/5 | 4/5 | 0/5 | 2/5 | 3/5 | 0/5 |
| sliding | | | | | | | | |
| durability | | | | | | | | |

As shown in Table 1, the anti-reflection films of Examples 1 to 4 are excellent in optical performances in view of their minimum reflectance and the total transmittance. These anti-reflection films are excellent in all of the three items, namely, the pen sliding durability, the scratch resistance and the abrasion resistance, and are high in surface hardness.

On the other hand, the optical performances of Comparative Examples 1 to 4 are equivalent in level to those of Examples, but Comparative Examples 1 to 4 are inferior in sliding durability and abrasion resistance to Examples because no polysiloxane resin was used in these Comparative Examples. Additionally, Comparative Example 2 is inferior in scratch resistance to Examples because the amount of the polysiloxane resin was not optimized. Comparative Example 3 is inferior in abrasion resistance to Examples.

### EXAMPLE 5

An acrylic adhesive sheet (product name: “Noncarrier”, manufacture by Lintec Corp.) was uniformly adhered, by use of a hand roller, onto the substrate surface, with no low refractive index layer formed thereon, of the anti-reflection film fabricated in Example 1. Then, the anti-reflection film was adhered onto the surface of a touch panel through the intermediary of the adhesive sheet. The touch panel thus treated gave a clearer image than before adhesion of the anti-reflection film.

### EXAMPLE 6

An acrylic adhesive sheet (product name: “Noncarrier”, manufacture by Lintec Corp.) was uniformly adhered, by use of a hand roller, onto the substrate surface, with no low refractive index layer formed thereon, of the anti-reflection film fabricated in Example 1. Then, the anti-reflection film was adhered onto the surface of the image display plate of a television set as an electronic image display plate. The television set thus treated gave a clearer image than before adhesion of the anti-reflection film.

Additionally, an embodiment may be modified as follows.

The material for the low refractive index layer may include a fluororesin for the purpose of improving the sliding property of the surface thereof.

The reflection of the anti-reflection film may be suppressed by forming as the hard coat layer a layer higher in refractive index than the high refractive index layer.

A anti-reflection film exhibiting antiglare effect may be formed by laminating a layer having irregularities on the hard coat layer.

1. A low refractive index layer for use in an anti-reflection film, the low refractive index layer being formed from a raw material composition containing silicon oxide, a crosslinking agent, a polymerization initiator and a polysiloxane resin, the main components of the raw material composition being silicon oxide and the crosslinking agent, wherein the polymerization initiator is 1 to 10 wt % and the polysiloxane is 1 to 5 wt % with respect to the sum of silicon oxide and the crosslinking agent.

2. The low refractive index layer according to claim 1, wherein the polysiloxane resin is a polyester modified polysiloxane or a polyether modified polysiloxane.

3. The low refractive index layer according to claim 2, wherein the polyester modified polysiloxane is a polyester modified dimethyl polysiloxane and the polyether modified polysiloxane is a polyether modified dimethyl polysiloxane.

4. The low refractive index layer according to claim 1, wherein the crosslinking agent is a (meth)acrylate monomer having functionality of 3 to 6.

5. The low refractive index layer according to claim 1, wherein the hard coat layer is a polymerized, cured substance of a composition containing a multifunctional (meth)acrylate.

6. A anti-reflection film comprising:
a substrate;
at least one intermediate layer arranged on the substrate and including a hard coat layer; and
a reflection reducing layer arranged on the intermediate layer, the reflection reducing layer including a high refractive index layer and a low refractive index layer arranged on the high refractive index layer, the low refractive index layer being formed from a raw material composition containing silicon oxide, a crosslinking agent, a polymerization initiator and a polysiloxane resin, wherein the content of the polymerization initiator is 1 to 10 wt % and the content of the polysiloxane resin is 1 to 5 wt % with respect to the sum of silicon oxide and the crosslinking agent.

7. The anti-reflection film according to claim 6, wherein the hard coat layer is an antiglare hard coat layer having a surface with irregularities formed thereon.

8. The anti-reflection film according to claim 6, wherein the refractive index of the high refractive index layer is 1.6 to 2.4 and the refractive index of the low refractive index layer is 1.3 to 1.5.

9. The anti-reflection film according to claim 6, wherein the substrate is a transparent resin film having a thickness of 10 to 500 μm.

10. The anti-reflection film according to claim 6, further comprising:
an adhesive layer arranged on a surface opposite to the surface on which the intermediate layer is laminated.

11. The anti-reflection film according to claim 6, wherein no visually identifiable scratches are formed on the low refractive index layer when a pen is moved in 50,000 back and forth strokes while the pen is in contact with the low refractive index layer with a load of 300 g.

12. The anti-reflection film according to claim 6, wherein no visually identifiable scratches are formed on the low refractive index layer when a piece of steel wool is moved in 50 back and forth strokes while the piece of steel wool is in contact with the low refractive index layer with a load of 250 g.

13. The anti-reflection film according to claim 6, wherein the reflection reducing layer is formed by means of a wet coating method.

14. The anti-reflection film according to claim 6, wherein the silicon oxide is a particular having an average particle size of 0.1 μm or less.

15. A touch panel comprising:
a display surface; and
an anti-reflection film arranged on the display surface, the anti-reflection film including:
a substrate;
at least one intermediate layer arranged on the substrate and including a hard coat layer; and
a reflection reducing layer arranged on the intermediate layer, the reflection reducing layer including a high refractive index layer and a low refractive index layer arranged on the high refractive index layer, the low refractive index layer being formed from a raw material composition containing silicon oxide, a crosslinking agent, a polymerization initiator and a polysiloxane resin, wherein the content of the polymerization initiator is 1 to 10 wt % and the content of the polysiloxane resin is 1 to 5 wt % with respect to the sum of silicon oxide and the crosslinking agent.

16. An electronic image display device comprising:
an image display plate; and
an anti-reflection film directly or indirectly adhered onto the image display plate, the anti-reflection film including:
a substrate;
at least one intermediate layer, inclusive of a hard coat layer, arranged on the substrate; and
a reflection reducing layer arranged on the intermediate layer, the reflection reducing layer including a high refractive index layer and a low refractive index layer arranged on the high refractive index layer, the low refractive index layer being formed from a raw material composition containing silicon oxide, a crosslinking agent, a polymerization initiator and a polysiloxane resin, wherein the content of the polymerization initiator is 1 to 10 wt % and the content of the polysiloxane resin is 1 to 5 wt % with respect to the sum of silicon oxide and the crosslinking agent.

17. A anti-reflection film for reducing reflection from a touch panel, the film comprising:
a transparent substrate;
a hard coat layer arranged on the transparent substrate;
a high refractive index layer laminated on the hard coat layer and having a refractive index of 1.6 to 2.4; and
a low refractive index layer laminated on the high refractive index layer, having a refractive index of 1.3 to 1.5, and including silicon oxide as a main component.

18. The anti-reflection film according to claim 17, wherein the low refractive index layer is formed from a raw material composition containing silicon oxide, a crosslinking-agent, a polymerization initiator and a polysiloxane, the weight ratio between silicon oxide and the crosslinking agent being 95:5 to 50:50, and the content of the polymerization initiator being 1 to 10 wt % and the polysiloxane resin being 1 to 5 wt % with respect to the sum of silicon oxide and the crosslinking agent.

19. The anti-reflection film according to claim 17, wherein the difference between the refractive index of the low refractive index layer and that of the high refractive index layer is 0.1 or more.

20. The anti-reflection film according to claim 17, wherein the hard coat layer has an antiglare property.
